(19) United States
(12) Patent Application Publication
(10) Pub. No.: US 2014/0214686 A1
(43) Pub. Date: Jul. 31, 2014

(54) APPLICATION STORE SYSTEM AND METHOD FOR IMPLEMENTING IN-APPLICATION PURCHASE FUNCTION

(71) Applicant: Yan Wu, Shenzhen (CN)

(72) Inventor: Yan Wu, Shenzhen (CN)

(73) Assignee: ZTE CORPORATION, Shenzhen (CN)

(21) Appl. No.: 14/240,769

(22) PCT Filed: Apr. 9, 2012
(86) PCT No.: PCT/CN2012/073675

§ 371 Date: Mar. 13, 2014

(30) Foreign Application Priority Data
Aug. 25, 2011 (CN) 201110245465.X

(51) Int. Cl. G06Q 20/12; G06Q 20/38

(52) U.S. Cl. CPC G06Q 20/123; G06Q 20/382
USPC 705/64; 705/39

(57) ABSTRACT

The disclosure provides an application store system and a method for implementing an IAP function. The system includes: a developer community functional entity and an online application store functional entity, and further includes a configuration module, configured to accept an operation of configuring, for an application, one or more purchasable items corresponding to the application and information corresponding to the one or more purchasable items, wherein the application is uploaded through the developer community functional entity; and an IAP processing module, configured to receive a purchase request from the application, and perform fee deduction according to information corresponding to a one or more purchasable items that the purchase request requests to purchase. Through the above solution, the cost of developing and maintaining an application having an in-program purchase function by a common developer is reduced.

### TECHNICAL FIELD

The disclosure relates to the field of communications, and in particular to an application store system and a method for implementing an In-Application Purchase (IAP) function.

### BACKGROUND

With the development of the 3^{rd} generation (3G) mobile communication and the development of smart mobile terminals (such as, smart phones), the mobile phone Internet is applied more and more widely. In such an environment, Apple starts to provide iPhone applications by an application store (apple application store) in 2008, and has made an approximate 1 billion downloads within a short time.

The use of such mobile phone application store has produced a large number of independent application developers. All of the operators, handset manufacturers and Internet companies will also put their application stores on the agenda, or have launched the online application stores.

With the development of the application store, a variety of changes also have taken place to the forms of the applications. The application stores need to provide a better system support capability for these different applications. A typical emerging application is in-building a store in an application. When downloading the application, a user can trigger a purchase request in the application. This application may be a game, when certain prop is needed in the game, the user can trigger a purchase request from a certain purchase entrance developed for the game by the developer. This application also may be an electronic reader, and users download an application program of an electronic reader for free and can purchase electronic books in the application program after starting the application program. According to statistics, this type of applications can improve the purchase intention of users. The developers urgently require the application store to provide them with such an application development system and the settlement ability so as to reduce the development cost of such applications. Furthermore, the competition of application stores will finally end in how to attract more developers; therefore, the application stores also should consider from the perspective of developers so as to provide them with a better system support, so as to facilitate the developers to develop application programs having IAP functions.

FIG. 1 is a basic architecture diagram of an application store system according to the related art. As shown in FIG. 1, in an ordinary application store system, the main function entities are an online application store and a developer community; brief explanations are respectively made as follows.

The main functional modules of the online application store in related technologies include a portal, an authentication module, an application distributing module, a supply and sale module, a service support module and an operation support module. The portal is mainly configured to provide an access entrance for WEB portal, WAP portal, mobile phone client or PC client, and mobile terminal users can easily search and download an application through the portal. The authentication module is configured to provide authentication to users and applications. The application distributing module is configured to provide various distribution ways for applications, i.e., functions related to application distributing, such as downloading to a computer, WAP PUSH to a mobile phone, sending the address via a short message, or directly downloading and installing via a client etc. The supply and sale module is configured to perform management to applications sold via the application stores, including the management to stores and goods shelves, the management to the on-line and off-line of the applications, and management to recommended ranking The online application store functional entity is mainly responsible for the interaction with the users, and the interaction between the online application store functional entity and the users is realized by the WEB interface operation or by an application interface, which is represented by “Web/Interface1” in the figure.

The main functions of the developer community in related technologies include: application upload, application management function, forum function, and developer wiki. The developer community functional entity is mainly responsible for the interaction between the developer and the application store system. The interaction between the developer and the developer community is realized by the WEB interface operation or by an SDK interface, which is represented by “Web/Interface3” in the figure.

The information interaction between the developer community and the online application store is realized through an “interface 2”, which interface is mainly responsible for synchronizing the application and application information approved by administrators from the developer community to the online application store.

At present, this application store system has had good development support ability for ordinary applications. However, in this system, if the developer hopes to develop an application with a built-in in-program purchase (also called In-Application Purchase or In-Application program Purchase, short for IAP) flow, a server needs to be set up by himself/herself to process these accounting requests, and at the same time, a corresponding integrated settlement function should also be provided. As such, the costs of development and maintenance are very high.

### SUMMARY

The disclosure provides an application store system and a method for implementing an IAP function, which can at least solve the above problem.

According to an aspect of the disclosure, an application store system is provided, and the application store system includes a developer community functional entity and an online application store functional entity, and further includes a configuration module, configured to accept an operation of configuring, for an application, one or more purchasable items corresponding to the application and information corresponding to the one or more purchasable items, wherein the application is uploaded through the developer community functional entity; and an In-Application Purchase (IAP) processing module, configured to receive a purchase request from the application, and perform fee deduction according to the information corresponding to one or more purchasable items that the purchase request requests to purchase.

Preferably, the configuration module and the IAP processing module are located in the developer community functional entity; or, the configuration module is located in the developer community functional entity, the IAP processing module is located in the online application store functional entity, and an interface between the developer community functional entity and the online application store functional entity is configured to synchronize the one or more purchasable items and the information corresponding to the one or more purchasable items to the IAP processing module.

Preferably, the IAP processing module includes: a purchase request interface, configured to receive the purchase request from the application, and perform fee deduction according to the information corresponding to the one or more purchasable items that the purchase request requests to purchase.

Preferably, the IAP processing module further includes: a purchase request responding interface, configured to return a purchase success message to the application under the condition that the purchase request interface performs the fee deduction successfully.

Preferably, the purchase request responding interface is configured to, under the condition that the one or more purchasable items for which the fee deduction is performed successfully are one or more items which has been downloaded in the application, return the purchase success message carrying information of the one or more purchasable items for which the fee deduction is performed successfully; and configured to, under the condition that the one or more purchasable items for which the fee deduction is performed successfully are one or more items which have not been downloaded in the application, return the purchase success message carrying an encrypted fee-deducted voucher.

Preferably, under the condition that the one or more purchasable items for which the fee deduction is performed successfully are one or more items to be downloaded in the application, the encrypted fee-deducted voucher carried in the purchase success message returned by the purchase request responding interface is obtained in the following way: using a check code corresponding to the application and applying an encryption algorithm to encrypt the fee-deducted voucher, wherein the check code, the encryption algorithm and a validation rule corresponding to the application are configured in an application server provided for the application to download the one or more purchasable items for which the fee deduction is performed successfully.

Preferably, the IAP processing module includes: an IAP query interface, configured to receive a query request from the application and inquire one or more purchasable items according to the query request; and an IAP query responding interface, configured to return inquired information of the one or more purchasable items to the application.

Preferably, the configuration module and the IAP processing module are located in an IAP management module of the application store system.

Preferably, the IAP management module is arranged in the developer community functional entity.

According to another aspect of the disclosure, a developer community functional entity is provided, and the developer community functional entity includes: a configuration module, configured to accept an operation of configuring, for an application, one or more purchasable items corresponding to the application and information corresponding to the one or more purchasable items, wherein the application is uploaded through the developer community functional entity.

According to still another aspect of the disclosure, an online application store functional entity is provided, and the online application store functional entity includes: an IAP processing module, configured to receive a purchase request from an application, and perform fee deduction according to information corresponding to one or more purchasable items that the purchase request requests to purchase, wherein one or more purchasable items and the information corresponding to the one or more purchasable items are synchronized to the IAP processing module by an interface between the developer community functional entity and the online application store functional entity.

Preferably, the IAP processing module includes: a purchase request interface, configured to receive the purchase request from the application, and perform fee deduction according to the information corresponding to the one or more purchasable items that the purchase request requests to purchase.

Preferably, the IAP processing module further includes: a purchase request responding interface, configured to return a purchase success message to the application under the condition that the purchase request interface performs the fee deduction successfully.

Preferably, the IAP processing module further includes: an IAP query interface, configured to receive a query request from the application and inquire one or more purchasable items according to the inquired request; and an IAP query responding interface, configured to return the inquired information of the one or more purchasable items to the application.

According to still another aspect of the disclosure, a method for realizing an In-Application Purchase (IAP) function is provided, and the method includes: in response to a user operation of selecting one or more purchasable items to be purchased, an application initiating a purchase request to the application store system; the application store system receiving the purchase request from the application, and performing fee deduction according to information corresponding to the one or more purchasable items that the purchase request requests to purchase.

Preferably, after the application store system receives the purchase request from the application, and performs the fee deduction according to the information corresponding to the one or more purchasable items that the purchase request requests to purchase, the method further includes: the application receiving a purchase success message returned by the application store system under the condition of performing the fee deduction successfully; under the condition that the one or more purchasable items for which the fee deduction is performed successfully are one or more items which have been downloaded in the application, the application authorizing to use the one or more purchasable items for which the fee deduction is performed successfully according to information of the one or more purchasable items for which the fee deduction is performed successfully which is carried in the purchase success message; and under the condition that the one or more purchasable items for which the fee deduction is performed successfully are one or more items which have not been downloaded in the application, the application sending an encrypted fee-deducted voucher carried in the purchase success message to an application server provided for the application to download the one or more purchasable items for which the fee deduction is performed successfully.

Preferably, after the application sends the encrypted fee-deducted voucher carried in the purchase success message to the application server provided for the application to download the one or more purchasable items for which the fee deduction is performed successfully, the method further includes: the application server decrypting and verifying the encrypted fee-deducted voucher, and transferring service content of the one or more purchasable items for which the fee deduction is performed successfully to the application under the condition that the fee-deducted voucher is valid.

Preferably, before the application initiates the purchase request to a purchase request processing module, the method further includes: the application initiating a query request to the application store system; the application store system inquiring one or more purchasable items according to the query request, and returning the inquired information of the one or more purchasable items to the application; and the application displaying the received information of the purchasable item.

By virtue of the above solution of the disclosure, the configuration module for realizing the configuration of one or more purchasable items, and the IAP processing module for performing interactive processing, such as fee deduction for a purchasable item, purchasable item query, etc., between the application and the application store system are arranged in the application store system, thereby solving the problem that the cost for the developer to develop applications is too high, and reducing the cost of developing and maintaining an application having an in-program purchase function for a common developer.

### BRIEF DESCRIPTION OF THE DRAWINGS

Drawings, provided for further understanding of the disclosure and forming a part of the specification, are used to explain the disclosure together with embodiments of the disclosure rather than to limit the disclosure. In the drawings:

FIG. 1 is a basic architecture diagram of an application store system according to the related art;

FIG. 2 is a structural block diagram of an application store system according to an embodiment of the disclosure;

FIG. 3 is a preferable structural block diagram I of an application store system according to an embodiment of the disclosure;

FIG. 4 is a preferable structural block diagram II of an application store system according to an embodiment of the disclosure;

FIG. 5 is a schematic diagram of an interface contained in the IAP processing module according to an embodiment of the disclosure;

FIG. 6 is a structural block diagram of an application store system according to another embodiment of the disclosure;

FIG. 7 is a preferable structural block diagram of an application store system according to another embodiment of the disclosure;

FIG. 8 is a preferable structural block diagram I of an IAP processing module in an application store system according to another embodiment of the disclosure;

FIG. 9 is a preferable structural block diagram II of an IAP processing module in an application store system according to another embodiment of the disclosure;

FIG. 10 is a flowchart of a method for realizing an IAP function according to an embodiment of the disclosure;

FIG. 11 is a diagram of an interface between an application program in operation and an application program server in an application store without providing the IAP function;

FIG. 12 is a relation diagram of interfaces among an application store, an in-program purchase functional module, a developer an a developer application server according to embodiment 1;

FIG. 13 is a schematic diagram of respectively arranging all the modules in the IAP function to different functional entities according to embodiment 2;

FIG. 14 is a flowchart of developer configuration and user performing IAP according to embodiment 2;

FIG. 15 is a flowchart of realizing a built-in IAP according to embodiment 3;

FIG. 16 is a flowchart of realizing IAP via an independent server according to embodiment 4;

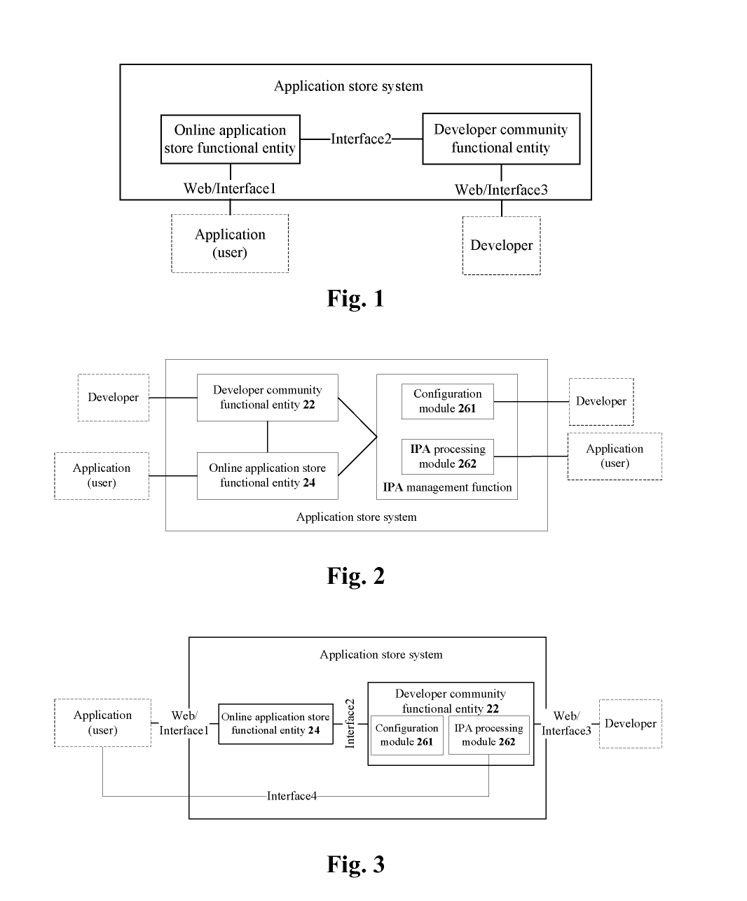

### DETAILED DESCRIPTION OF THE EMBODIMENTS

The disclosure is described below with reference to the accompanying drawings and embodiments in detail. It should be noted that the embodiments of the disclosure and the features of the embodiments can be combined with each other if there is no conflict.

An embodiment of the disclosure provides an application store system. FIG. 2 is a structural block diagram of an application store system according to an embodiment of the disclosure, as shown in FIG. 2, the system includes a developer community functional entity 22 and an online application store functional entity 24, and also includes a configuration module 261, configured to accept the operation of configuring, for an application uploaded through the developer community functional entity 22, one or more corresponding purchasable items of the application and information corresponding to the one or more purchasable items; and an IAP processing module 262, configured to provide interface process between the application and the application store system according to the configuration in the configuration module 261, and preferably, configured to receive a purchase request from the application and perform fee deduction according to information corresponding to one or more purchasable items that the purchase request requests to purchase. The above configuration module 261 and IAP processing module 262 commonly form the IAP management function used for processing the interactive interface between the application store and applications, such as IAP item purchase request and IAP purchasable item query related interfaces.

With the above system, when developing an application having an IAP function, a developer does not need to configure a purchase function in an application server, which simplifies the complexity for the developer to develop an application. Furthermore, the management and maintenance to the in-program purchasable item can be performed more conveniently through this architecture, and the operation of a user is simplified.

FIG. 3 is a preferable structural block diagram I of an application store system according to an embodiment of the disclosure, as shown in FIG. 3, the modules related to the IAP management function (at least including the configuration module 261 and the IAP processing module 262) can be wholly arranged in the developer community functional entity 22. In FIG. 3, the interaction between the online application store functional entity and the user is realized by the WEB interface operation or by an application interface, which is represented by “Web/Interface1” in the figure. The developer community functional entity is mainly responsible for the interaction between the developer and the application store system. The interaction between the developer and the developer community is realized by the WEB interface operation or by an SDK interface, which is represented by “Web/Interface3” in the figure, and the management and configuration of IAP are also completed through this interface. The information interaction between the developer community and the online application store is realized through the “interface 2”, which interface is mainly responsible for synchronizing the application and application information approved by administrators from the developer community to the online application store. Since there is no interface between the developer community and the application, when the IAP processing module is configured in the developer community, an “interface 4” (of which the function is realized by the IAP processing module 262) needs to be independently provided to complete the information interaction between the application and the IAP processing module.

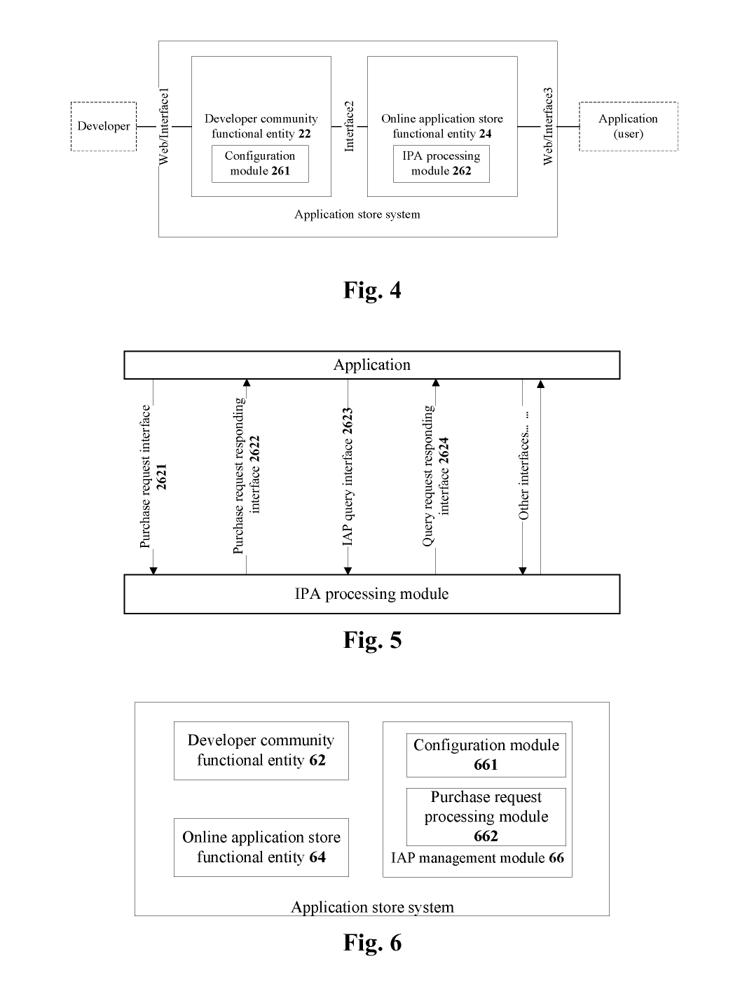

FIG. 4 is a preferable structural block diagram II of an application store system according to an embodiment of the disclosure. As shown in FIG. 4, all the modules of the IAP management function can also be respectively arranged in the developer community functional entity 22 and the online application store functional entity 24. The configuration module 261 is configured in the developer community functional entity 22, and the IAP processing module 262 is configured in the online application store functional entity 24. The configuration module 261 is used when a developer configures one or more IAP purchasable items. The IAP processing module 262 mainly processes the interaction of relevant information about IAP item query and purchase between the application and the application store system. The developer community provides an entrance for the developer to upload and configure relevant information of the application program; therefore, the IAP configuration module is configured in the developer community, after the developer uploads the application, one or more IAP items in the application can be configured together. FIG. 4 differs from the preferable structural block diagram I as shown in FIG. 3 in that, since the online application store system is accessed by a user through an application store or WEB, which involves the interaction between the user and the application store system; therefore, when the IAP processing module which is responsible for the interface interaction between the application and the application store system is placed in the online application store functional module, there is no information of IAP purchasable items in the online application store; therefore, an IAP information synchronization interface between the developer community and the online application store needs to be added (can be realized by adding an interface between the developer community functional entity 22 and the online application store functional entity 24, but preferably, the interface 2 currently located between the developer community functional entity 22 and the online application store functional entity 24 can be reused, and the above synchronization process is realized by extending the interface 2) so as to synchronize information of the one or more application related IAP purchasable items configured by the developer to the online application store functional entity. In the case that the online application store functional entity has IAP purchasable item relevant information, the IAP configuration module can inquire relevant information in the online application store functional entity only when the user performs operations such as inquiring, purchasing etc., with the IAP configuration module through the interface in the application.

In FIG. 4, the interaction between the online application store functional entity and the user is realized by the WEB interface operation or by an application interface, which is represented by “Web/Interface1” in the figure, and the interaction between the application and the IAP processing module is also completed by this interface. The developer community functional entity is mainly responsible for realizing the interaction between the developer and the application store system by the WEB interface operation or by an SDK interface, which is represented by “Web/Interface3” in the figure, and the management and configuration of IAP are also completed through this interface. The information interaction between the developer community and the online application store is realized through the “interface 2”, the interface is mainly responsible for synchronizing the application, application information and IAP purchasable item relevant information which are approved by administrators from the developer community to the online application store.

FIG. 5 is a schematic diagram of an interface included in an IAP processing module according to an embodiment of the disclosure. As shown in FIG. 5, an interface processing and managing module 262 mainly includes the following several main interfaces: a purchase request interface 2621, configured to receive a purchase request from the application and perform fee deduction according to information corresponding to a one or more purchasable items that the purchase request requests to purchase; a purchase request responding interface 2622, configured to return information that whether the purchase is performed successfully under the condition that the purchase request interface 2621 performs fee deduction successfully; an IAP query interface 2623, configured to receive a query request from the application and inquire one or more purchasable items according to the query request; and a query request responding interface 2624, configured to return inquired information of the one or more purchasable items to the application. The query request may indicate to inquire one or more purchasable items corresponding to the application.

It should be noted that, in order to simplify the complexity of a developer to develop an application, the application store system needs to have the function of supporting fee deduction (specifically may be that the application store system completes the fee deduction on its own, or the application store system completes the fee deduction through an external settlement system), so that the developer does not need to provide a purchase function in the application server when developing an application having the IAP function. In this application store system, the IAP processing module 262 (specifically may be the purchase request interface 2621 in the IAP processing module 262) may be configured to, after receiving a purchase request from the application, perform fee deduction through a purchase functional module arranged in the application store system or control an external settlement system by an external interface to perform fee deduction, according to information corresponding to one or more purchasable items that the purchase request requests to purchase.

In practical application, the content carried by the returned purchase success message can be determined according to the type of the application purchasable item. For example, the IAP processing module 262 (specifically may be the purchase request responding interface 2622 in the IAP processing module 262) returns, under the condition that the one or more purchasable items for which the fee deduction is performed successfully are one or more items which have been downloaded in the application, the purchase success message carrying information of the one or more purchasable items for which the fee deduction is performed successfully, in such a case, the application can determine to unlock this purchasable item or these purchasable items for the user according to the specific one or more purchasable items for which the fee deduction is performed successfully; and returns, under the condition that the one or more purchasable items for which the fee deduction is performed successfully are one or more items which have not been downloaded in the application, the purchase success message carrying an encrypted fee-deducted voucher, in such case, the application can send the encrypted fee-deducted voucher to an application server, so that the application server can determine whether to return the specific service content to the application after decrypting and verifying the fee-deducted voucher. In practical operation, a plurality of manners can be used to assist the IAP processing module 262 to judge the type of a purchasable item, for example, information of a purchasable item configured in the configuration module 261 can include one or more parameters to classify the IAP purchasable items, one type is built-in IAP purchasable items, and another type is purchasable items needing content downloading, with the extension of functions in the application, purchasable items of other types may also be included. In this way, the IAP processing module 262 can determine the type of the current purchasable item according to the above parameters so as to decide the subsequent processing manners.

The fee-deducted voucher can be encrypted by using a verification code, for example, the encrypted fee-deducted voucher carried in the purchase success message returned by the IAP processing module 262 (specifically may be the purchase request responding interface 2622 in the IAP processing module 262) is obtained in the following way: using a check code corresponding to the application (one optional manner to obtain the check code is that the developer applies for a fee deduction check code for his/her own application in an application store) and applying an encryption algorithm to encrypt the fee-deducted voucher, wherein the check code, the encryption algorithm and a validation rule corresponding to the application are configured in an application server provided for the application to download the one or more purchasable items for which the fee deduction is performed successfully. After receiving the encrypted fee-deducted voucher, a server uses the decryption algorithm and validation rules to verify the fee deduction, and the one or more purchasable items to be downloaded for which the fee deduction is performed successfully can be delivered to the application program after the verification is passed. The encryption and decryption algorithm and validation rules are provided by the application store system (for example, can be regulated in a development manual).

It should be noted that, in practical application, the functions of all the interfaces of the IAP processing module in the above IAP management function can be realized by arranging modules having corresponding functions in the application store system. For example, the function of the purchase request interface can be achieved by arranging a purchase request module, the purchase request responding interface can be achieved by arranging a purchase request responding module, the IAP query interface can be achieved by arranging a query request processing module, the IAP query responding interface can be achieved by arranging a query request responding module, specific descriptions are made in detail in the subsequent description about the embodiments of the application store system. The application can equally complete the sending of the processing request and/or the receiving of the processing response by modules having these functions so as to achieve the entire purchase function.

Another embodiment of the disclosure provides a developer community functional entity, including the above-described configuration module which is used to accept the operation of configuring, for an application which is uploaded through the developer community functional entity, one or more purchasable items corresponding to the application and information corresponding to the one or more purchasable items.

Yet another embodiment of the disclosure provides an online application store functional entity, including an IAP processing module, configured to receive a purchase request from an application, and perform fee deduction according to information corresponding to one or more purchasable items that the purchase request requests to purchase, wherein one or more purchasable items and information corresponding to the one or more purchasable items are synchronized to the IAP processing module by an interface between the developer community functional entity and the online application store functional entity.

The IAP processing module may include one or more of the above-described purchase request interface, purchase request responding interface, IAP query interface and query request responding interface.

Another embodiment of the disclosure provides an application store system. FIG. 6 is a structural block diagram of an application store system according to another embodiment of the disclosure, as shown in FIG. 6, the system includes a developer community functional entity 62 and an online application store functional entity 64, and also includes an IAP management module 66, wherein the IAP management module 66 includes a configuration module 661, configured to accept the operation of configuring, for an application uploaded through the developer community functional entity 62, one or more purchasable items corresponding to the application and information corresponding to the one or more purchasable items; and a purchase request processing module 662, also called payment request processing module, configured to receive a purchase request from the application, and perform fee deduction according to information corresponding to one or more purchasable items that the purchase request requests to purchase.

With the above system, when developing an application having an IAP function, a developer does not need to configure a purchase function in an application server, which simplifies the complexity for the developer to develop an application. Furthermore, the management and maintenance to the in-program purchasable item can be performed more conveniently through this architecture, and the operations of the user and the developer are simplified.

It should be noted that, in order to simplify the complexity of a developer to develop an application, the application store system needs to have the function of supporting fee deduction (specifically may be that the application store system completes the fee deduction on its own, or the application store system completes the fee deduction through an external settlement system), so that the developer does not need to provide a purchase function when developing an application having the IAP function. In this application store system, the purchase request processing module 662 may be configured to, after receiving a purchase request from the application, perform fee deduction through a purchase functional module arranged in the application store system or control an external settlement system by an external interface to perform fee deduction, according to information corresponding to one or more purchasable items that the purchase request requests to purchase.

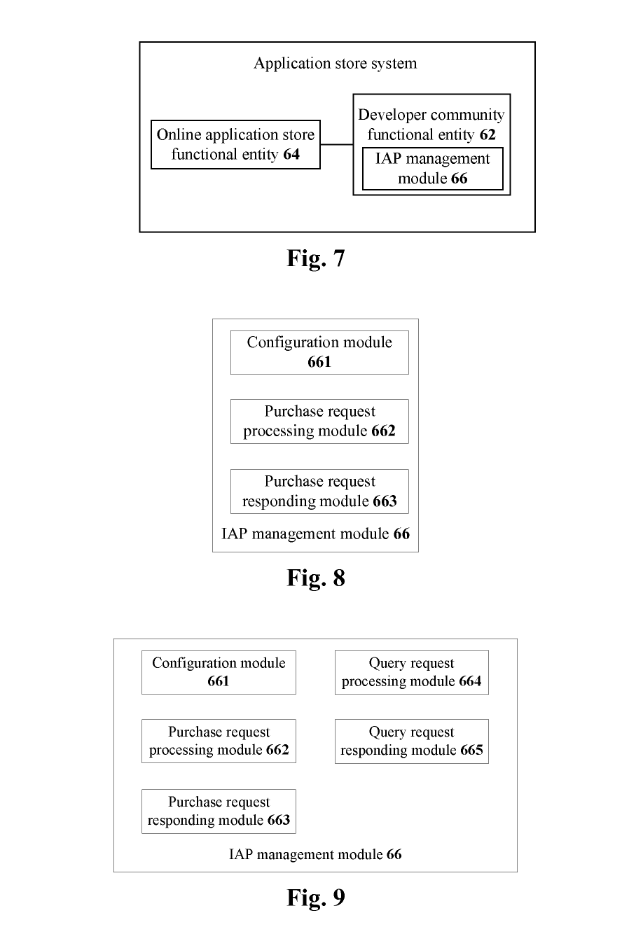

FIG. 7 is a preferable structural block diagram of an application store system according to an embodiment of the disclosure. As shown in FIG. 7, the IAP management module 66 can be arranged in the developer community functional entity 62.

FIG. 8 is a preferable structural block diagram I of an IAP management module in an application store system according to another embodiment of the disclosure. As shown in FIG. 8, the IAP management module 66 can also include a purchase request responding module 663, also called a payment request responding module, configured to return a purchase success message to the application under the condition that the purchase request processing module 662 performs fee deduction successfully.

In practical application, the content carried by the returned purchase success message can be determined according to the type of the application purchasable item. For example, the purchase request responding module 663 returns, under the condition that the one or more purchasable items for which the fee deduction is performed successfully are one or more items which have been downloaded in the application, the purchase success message carrying information of one or more purchasable items for which the fee deduction is performed successfully, in such case, the application can determine and unlock this purchasable item or these purchasable items for the user according to the specific one or more purchasable items for which the fee deduction is performed successfully; and returns, under the condition that the one or more purchasable items for which the fee deduction is performed successfully are one or more items which have not been downloaded in the application, the purchase success message carrying an encrypted fee-deducted voucher, in such case, the application can send the encrypted fee-deducted voucher to an application server, so that the application server can determine whether to return the specific service content to the application after decrypting and verifying the fee-deducted voucher. In practical operation, a plurality of manners can be used to assist the purchase request responding module 663 to judge the type of the purchasable item, for example, the information of a purchasable item configured in the configuration module 661 can include one or more parameters to classify the IAP purchasable item, one type is built-in IAP purchasable items, and another type is purchasable items needing content downloading, with the extension of functions in the application, purchasable items of other types may also be included. In this way, the purchase request responding module 663 can determine the type of the current purchasable item according to the above parameters so as to decide the subsequent processing manners.

The fee-deducted voucher can be encrypted by using a verification code. For example, the encrypted fee-deducted voucher carried in the purchase success message returned by the purchase request responding module 663 is obtained in the following way: using a check code corresponding to the application (one optional manner to obtain the check code is that the developer applies for a fee deduction check code for his/her own application in an application store) and using an encryption algorithm to encrypt the fee-deducted voucher, wherein the check code, the encryption algorithm and a validation rule corresponding to the application are configured in an application server provided for the application to download the one or more purchasable items for which the fee deduction is performed successfully. After receiving the encrypted fee-deducted voucher, a server uses a decryption algorithm and validation rules to verify the fee deduction, and the one or more purchasable items to be downloaded for which the fee deduction is performed successfully can be delivered to the application program after the verification is passed. The encryption and decryption algorithm and validation rules are provided by the application store system (for example, can be regulated in a development manual).

FIG. 9 is a preferable structural block diagram II of an IAP processing module in an application store system according to another embodiment of the disclosure. As shown in FIG. 9, the IAP management module 66 can also include a query request processing module 664, configured to receive a query request from the application and inquire one or more purchasable items according to the query request; and a query request responding module 665, configured to return inquired information of the one or more purchasable items to the application. The query request may indicate to inquire one or more purchasable items corresponding to the application, and the query request processing module 664 then inquires the one or more purchasable items according to the query request so as to correspondingly return information of corresponding one or more purchasable items.

It should be noted that, in practical application, all the functions of the modules in the above IAP management module 66 can be realized by arranging interfaces having corresponding functions, and the application can complete the sending of the processing request and/or the receiving of the processing response by the interfaces having these functions so as to realize the entire purchase function.

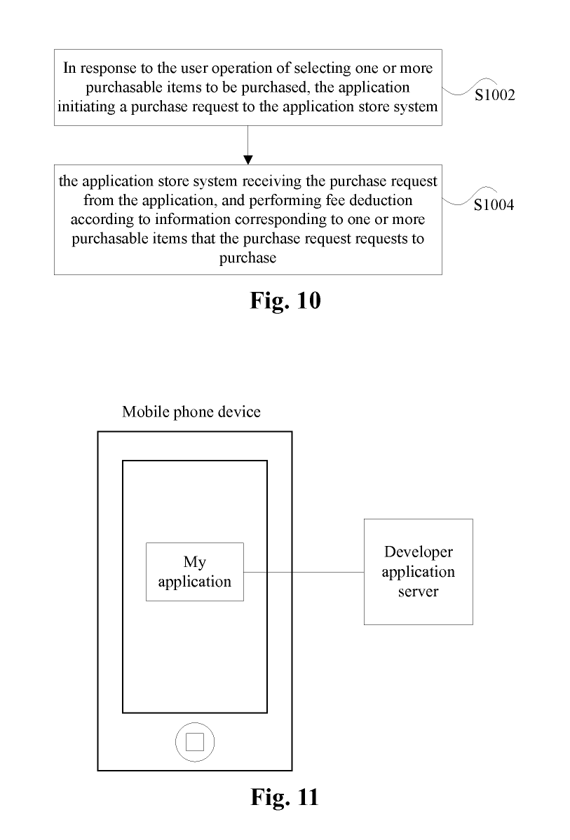

FIG. 10 is a flowchart of a method for realizing an IAP function according to an embodiment of the disclosure. The method includes:

Step S1002, in response to a user operation of selecting one or more purchasable items to be purchased, the application initiates a purchase request to the application store system;

Step S1004, the application store system receives the purchase request from the application, and performs fee deduction according to information corresponding to the one or more purchasable items that the purchase request requests to purchase.

The method is suitable for structures of various kinds of application store systems. For example, if the structure of the application store system in the above first embodiment is adopted to realize the method, then in Step S1002, the application should send a purchase request to the IAP processing module 262 of the application store system, in Step S1004, the IAP processing module 262 of the application store system receives the purchase request from the application and performs fee deduction according to information corresponding to the one or more purchasable items that the purchase request requests to purchase. If the structure of the application store system in the above second embodiment is adopted to realize the method, then in Step S1002, the application should send a purchase request to the purchase request processing module 662 of the application store system, in Step S1004, the purchase request processing module 662 of the application store system receives the purchase request from the application and performs fee deduction according to information corresponding to the one or more purchasable items that the purchase request requests to purchase;

With the above method, an application having an IAP function can purchase one or more purchasable items through the application store system, and a developer does not need to configure a purchase function in an application server, which simplifies the complexity of a developer to develop an application. It should be noted that, in order to simplify the complexity of a developer to develop an application, the application store system needs to have the function of supporting fee deduction (specifically may be that the application store system completes the fee deduction on its own, or the application store system completes the fee deduction through an external settlement system), so that the developer does not need to provide a purchase function in the application server when developing an application having the IAP function. In this embodiment, after receiving a purchase request from the application, the application store system can perform fee deduction through a purchase functional module arranged in the application store system or control an external settlement system by an external interface to perform fee deduction, according to information corresponding to one or more purchasable items that the purchase request requests to purchase.

In order to facilitate the judging and processing of the application after initiating the purchase request, after the application store system receives the purchase request from the application and performs fee deduction according to information corresponding to the one or more purchasable items that the purchase request requests to purchase, the method also includes the following steps: the application receives the purchase success message returned by the application store system under the condition of performing fee deduction successfully; under the condition that the one or more purchasable items for which the fee deduction is performed successfully are one or more items which have been downloaded in the application, the application authorizes to use the one or more purchasable items for which the fee deduction is performed successfully according to information of the one or more purchasable items for which the fee deduction is performed successfully and carried in the purchase success message; and under the condition that the one or more purchasable items for which the fee deduction is performed successfully are one or more items which have not been downloaded in the application, the application sends the encrypted fee-deducted voucher carried in the purchase success message to an application server provided for the application to download the one or more purchasable items for which the fee deduction is performed successfully. With this flow, as for the purchasable items which do not need downloading, after directly judging whether the purchase is performed successfully, the application can decide whether to open the item to the user; and as for purchasable items which need downloading, the application can send the fee-deducted voucher to the application server to request to download the service or the content which has been paid. After the application sends an encrypted fee-deducted voucher carried in the purchase success message to an application server, the application server can decrypt and verify the encrypted fee-deducted voucher, and transfer the service content of the one or more purchasable items for which the fee deduction is performed successfully to the application under the condition that the fee-deducted voucher is valid. The above purchase response processing procedure is suitable for structures of various kinds of application store systems. For example, if the structure of the application store system in the above first embodiment is adopted to realize the purchase response, then the purchase request responding interface 2622 of the application store system returns the purchase response; if the structure of the application store system in the above second embodiment is adopted to realize the purchase response, then the purchase request responding module 663 of the application store system returns the purchase response.

Before the application sends the purchase request to the purchase request processing module, the application can inquire information of one or more purchasable items from the application store system, so that a user can decide whether to purchase the purchasable item. Specifically, the following flow can be adopted for processing: the application initiates a query request to the application store system; the application store system inquires one or more purchasable items according to the purchase request and returns inquired information of the one or more purchasable items to the application; and the application displays the received information of the one or more purchasable items. The above purchasable item query processing procedure is suitable for structures of various kinds of application store systems. For example, if the structure of the application store system in the above first embodiment is adopted to realize the purchasable item query, then the IAP query interface 2623 of the application store system receives the query request, and the IAP query responding interface 2624 returns the query result. If the structure of the application store system in the above second embodiment is adopted to realize the one or more purchasable items query, then the query request processing module 664 of the application store system receives the query request, and the query request responding module 665 returns the query result.

Under the practical situation, there can be various processes for the application to initiate the purchasable item query, and two query processes which may be widely used are enumerated as follows.

(1) As for inquiring built-in purchasable items, the application initiates a query request for indicating to inquire all the purchasable items corresponding to the application; the application store system inquires the information of all the purchasable items corresponding to the application and returns same to the application; and the application displays the received information of the purchasable items for the user.

(2) As for non-built-in purchasable items, i.e., IAP purchasable items the content of which needs to be downloaded from a server, the application should send a query request to an application server for inquiring purchasable items which can be purchased; the application server returns a list of purchasable item identifiers of the purchasable items which can be purchased to the application; the application initiates a query request carrying one or more purchasable item identifiers to be inquired; the application store system inquires information of the one or more purchasable items corresponding to the one or more purchasable item identifiers to be inquired and returns the information to the application; and the application displays the received information of the one or more purchasable items for the user.

Embodiments 1-4 described below synthesize the technical solutions of a plurality of above-mentioned preferred embodiments. It should be noted that, the following embodiment 1 and embodiment 2 are described on the basis of the structure in the above-mentioned first embodiment about the application store system, those skilled in the art should understand that the following embodiments are likewise suitable to the structure in the above-mentioned second embodiment about the application store system, the specific implementation process is similar, thereby needing no further description.

Embodiment 1

The present embodiment describes the basic architecture of the application store system added with the IAP functional module. The advantages of adopting the application store system in the present embodiment, with respect to the online application store system in the prior art, are described in detail in the way of examples.

As shown in FIG. 2, on the basis of the basic structure of the application store, the IAP function is added. The IAP function mainly consists of an IAP configuration module and an IAP processing module. The IAP configuration module is mainly responsible for providing an entrance for managing in-program purchase products for the developer, and the IAP processing module provides an integrated purchase settlement process for the user when using the application containing the in-program purchase function. The IAP configuration module and the IAP processing module may be a constituent part of a developer community, and also may be placed in other functional entities in the application store.

The purchasable items in the application can be divided into two forms, one form is the built-in IAP purchasable items, and the other form is the purchasable items needing content downloading, brief explanations are respectively made as follows.

Under the circumstance of the built-in IAP purchasable items, the contents and services have been downloaded by the user in the program, and certain content or service can be unlocked only after being purchased by the user. Taking a game as an example, certain level in the game can be played only after being purchased. In an application store without providing the IAP function in the related art, if a user needs to realize such function, a game server must be provided for the user to complete the purchase. Furthermore, in an application store providing the IAP function, the function of the game can be realized by establishing one or more purchasable items and pricing the one or more items after uploading the application, and only after the user purchases the IAP item from the application store can the level be unlocked to continue the game.

Under the circumstance of the purchasable items needing content downloading, the user contents and services are provided by the developer on the application server, after purchasing certain product of IAP, a user downloads corresponding content or uses certain service on a corresponding application server. Taking a reader application program which can buy magazines as an example, the selling price of the reader is 0 Yuan, the profits are mainly hoped to be obtained by selling magazines, e.g., each issue of the magazines sells at 5 Yuan. If the user needs to realize the functions similar to in-program purchase, all the functions need to be completed in a self-establishing application program server. The developer needs to upload the application program to the application store for selling, the price being 0 Yuan; and at the same time, an application program server needs to be established on its own, when the application program runs, the application program server needs to provide the application program with several basic interfaces and functions: requests of inquiring purchasable magazines and purchasing magazines, and magazine delivering and purchasing interfaces, and internal basic management functions of uploading magazines, managing magazine information and managing users also have to be provided.

As shown in FIG. 11, it shows a diagram of the interface relationship between an application program in operation and an application program server in an application store without providing IAP function. After the application program is downloaded, the application will only perform information interaction and content delivery with its own application program server. The application program server needs to provide all the functions of content delivery, service supply, in-program purchase process, and purchase process. It can be seen that as the application program server with so many functions needs to be provided, it is very high in development cost to provide the application program with this in-program purchase function in the application store not providing the IAP function. With regard to the problem of purchase, it is not only the problem of development cost, the cooperation with internet banks is also necessary.

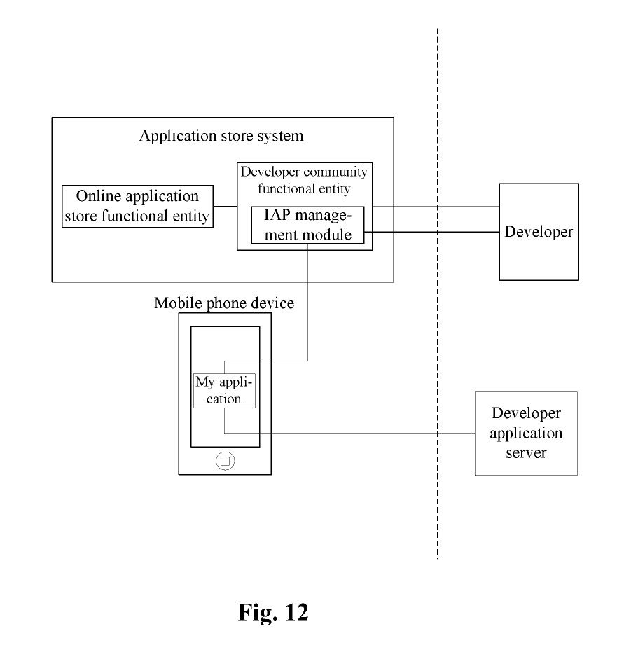

As shown in FIG. 12, it shows the interface relationship, in an application store providing an IAP function, between an application program in operation and an application program server, and between an application program in operation and the application store. When developing an application using the application store with the IAP function, after the application is downloaded by the user, the user can trigger a purchase in the application, the information interaction with the application store still needs to be performed, if a purchasing behaviour is needed, the user purchases from the application store. The content and service are provided in the application program server, after purchasing successfully, the user can make a content/service request to the application program so as to obtain the corresponding purchased content/service. For example, if a developer wants to develop a magazine reader, the application program needs to be uploaded to the application store for selling, the price being 0 Yuan, an IAP purchasable item is established for the application in the IAP management, for example, the name is “2011, April, XX magazine”, and the price is 5 Yuan. At the same time, an application program server also needs to be established for providing a service of delivering magazine contents for the application. When the user purchases the magazine, the purchasing expense is given to the application store, after the purchase is performed successfully, the corresponding purchased magazine can be downloaded from the application server.

For the developer, the developing difficulty and cost are greatly reduced by developing such an application in the application store providing the IAP function. Only the basic content management and content delivery service need to be provided on the self-established application program server, and the management of a purchase process and purchasable items has been realized in the application store.

### Embodiment 2

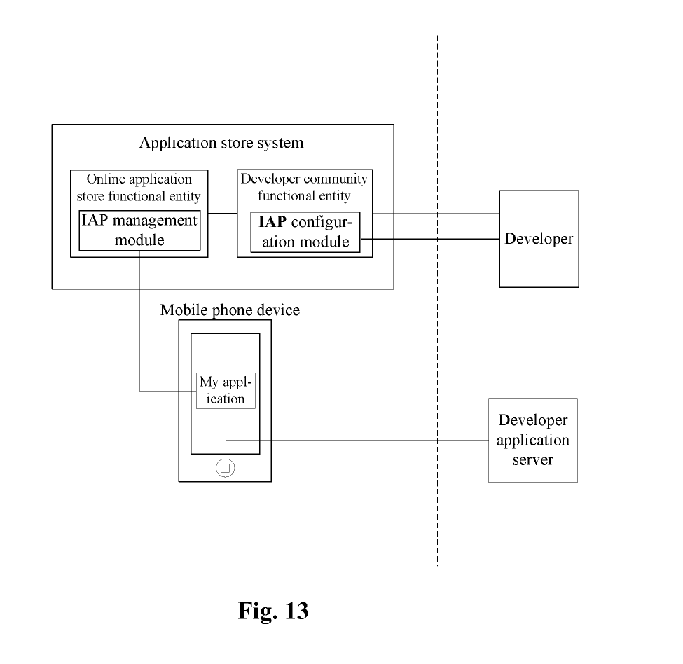

The IAP function can be divided, in terms of modules, into a configuration module and an IAP processing module, wherein the configuration module and the IAP processing module can be respectively arranged in the online application store and the developer community, as shown in FIG. 13. The present embodiment describes the process of realizing the IAP function in the case that the IAP functional modules are separately arranged.

Under the case that the configuration module and the IAP processing module are separately arranged, as shown in FIG. 13, a synchronization interface of IAP item relevant information between the developer community and the online application store needs to be added. That is to say, when the developer configures an IAP item in the developer community, the IAP item takes effect after being checked, the developer community synchronizes relevant information of the IAP item to the online application store system. In this way, when the application interacts with the IAP processing module, the online application store system can inquire relevant information of the IAP item in its own system.

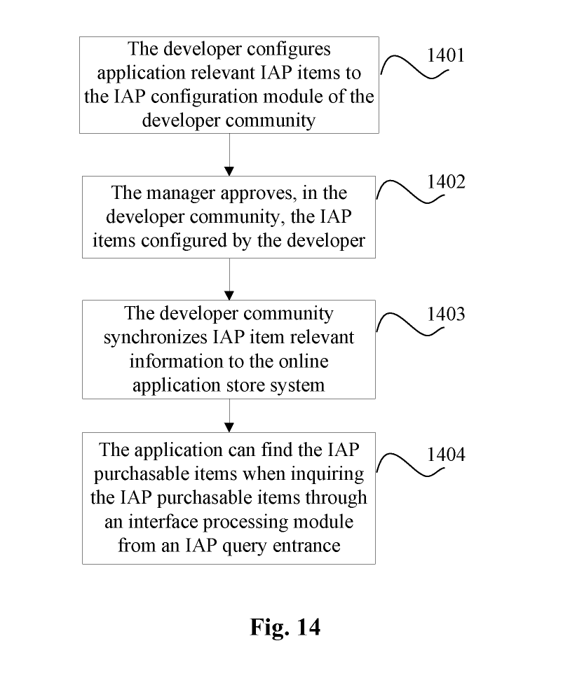

Under the case that the IAP configuration module and the IAP processing module are separately arranged, the flow from the developer configuring the IAP purchasable item to the user purchasing the IAP purchasable item, as shown in FIG. 14, includes the following steps:

Step 1401, the developer uploads the application on the developer community, and configures application relevant IAP items to the IAP configuration module;

Step 1402, the manager approves, in the developer community, the application of the developer and the configured IAP item;

Step 1403, the developer community synchronizes IAP item relevant information to the online application store system; and

Step 1404, after the application is purchased, the user can inquire IAP purchasable items through the interface provided by the application in the application and purchases same.

In the preferable structure of placing the IAP configuration module in the developer community and placing the IAP processing module in the online application store system, the synchronization of the IAP information from the developer community to the online application store system, that is Step 1403, is an essential step. As the application only performs information interaction with the IAP processing module, if the IAP information is not synchronized from the developer community to the online application store system, the IAP processing module is unable to obtain IAP relevant information for the application to inquire.

As regards the case that the IAP configuration module and the IAP processing module are separately arranged, it mainly differs from the structure of placing all the IAP functional modules in the developer community in embodiment 1 in that the IAP information synchronization function between the developer community and the online application store is added. Of course, what functional entity in the application store the IAP configuration module and the IAP processing module are placed in is determined by particular realization. In embodiments 3 and 4, “the application store system” is uniformly used to describe the IAP flow, and this description is suitable for both of the two architectures and also suitable for other online application store architectures which have similar deformation and same principle.

### Embodiment 3

This embodiment describes the method for developing an application program with IAP function by using an application store added with IAP functional modules in detail. It is assumed that the application is a game, and then certain level of the game can be continued only after being purchased. After uploading the game, the developer needs to configure a purchasable IAP item for the game in the IAP management module, supposed that the IAP item is a game prop, the name being “XX game, XX prop” and the price being 1 Yuan. After a game player buys the prop, the application store returns a purchase success message to the game, and then the player can use the prop in the game.

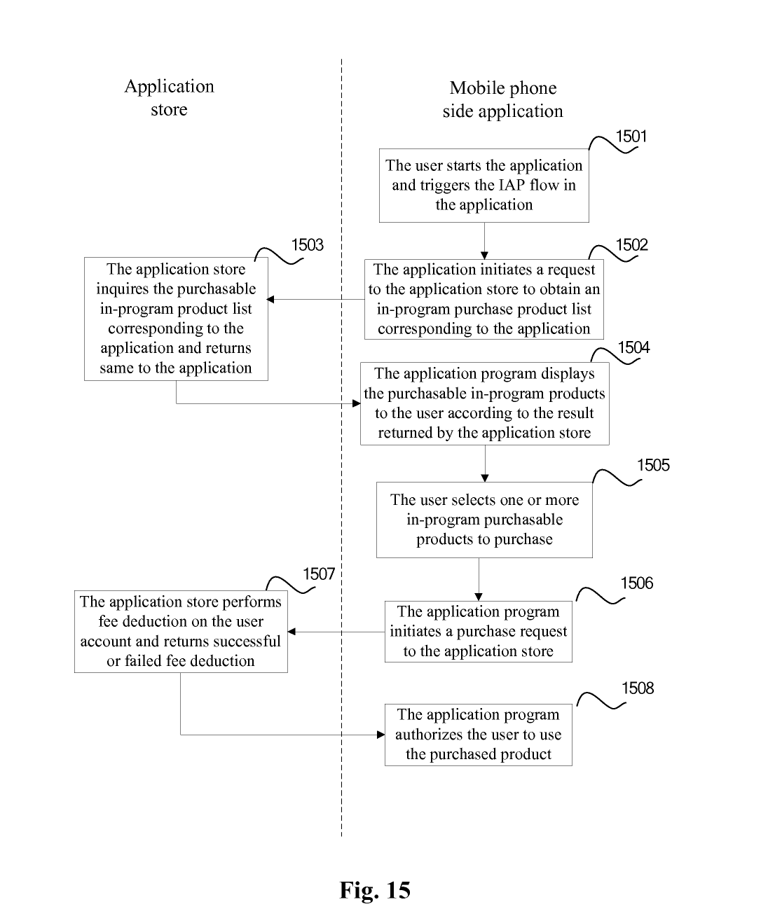

FIG. 15 is a flowchart of realizing a built-in IAP according to an embodiment 3, the steps of the following embodiment mainly describe the steps of purchasing props in the process of the user using the application, and the whole flow of realizing this kind of in-program purchase can be clearly understood from the description of the steps:

Step 1501, the user starts the application program and triggers the IAP flow in the process of using the application program. Taking a game as an example, the trigger may be that the user clicks a “prop purchase” button in the game to call out the page of purchasable props.

Step 1502, the application program initiates a request to the IAP functional module of the application store via an IAP purchasable item query interface.

Step 1503, the application store IAP module inquires the IAP purchasable items corresponding to the application and returns the result to the application program by a responding interface of the IAP purchasable item query interface.

Step 1504, the application program displays the IAP purchasable items on the interface for the user to select according to the contents returned by the interface.

Step 1505, the user selects to purchase one or more IAP purchasable items, which may be a game prop or a plurality of game props.

Step 1506, the application program initiates a purchase request to the application store according to the selection of the user.

Step 1507, after the application store performs fee deduction successfully, the application store returns a purchase success message to the game, and the application authorizes the user to use the purchased one or more props.

In the above-mentioned embodiment, when the developer develops the game, purchasable props have been configured for the game, and the authentication when using the props is configured too. That is to say, after the user purchases a prop, there is no need to update the version of the application program or download the prop, instead, it is only needed to judge whether the prop can be used in the application program.

As regards the applications which need to download contents after being purchased, they will be described in embodiment 4 below.

### Embodiment 4

This embodiment describes the method for realizing an application program with IAP function by using an application store added with IAP functional modules in detail. In this application program, there are purchasable items, the content of which needs to be obtained by accessing an application server. It is supposed that the application is a magazine reader. The user downloads the magazine reader in the application store for free; however, if wanting to read magazines, the user needs to order the magazine and pays for it.

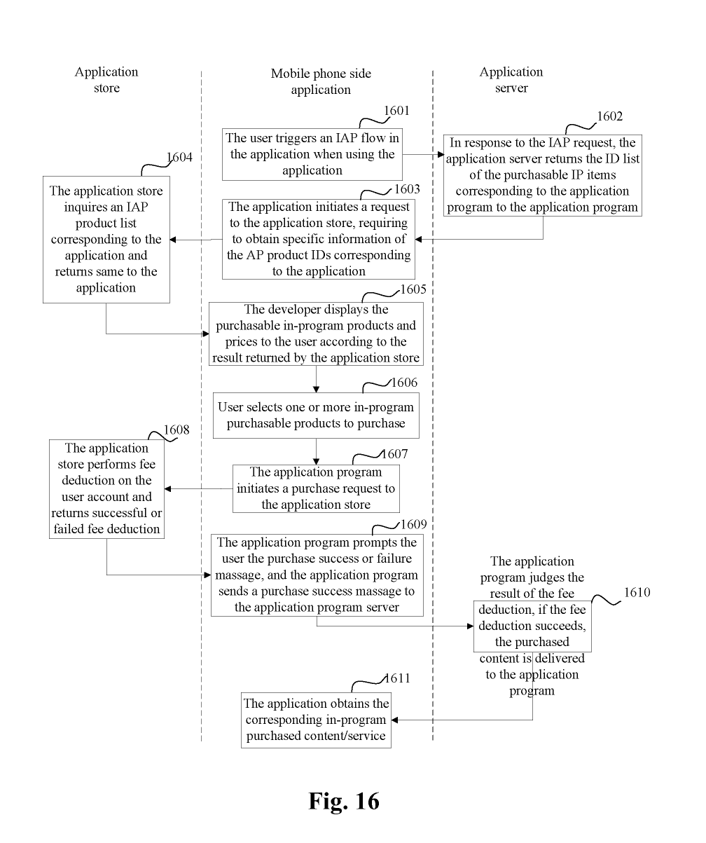

FIG. 16 is a flowchart of realizing in-program purchase via an independent server according to an embodiment 3, the steps of the following embodiment mainly describe the steps of purchasing magazines in the process of the user using the magazine reader, and the whole flow of realizing this kind of IAP can be clearly understood from the description of the steps.

Step 1601, the user starts the magazine reader application program in a mobile phone, clicks to refresh the latest magazine, and then the application program accesses the magazine server to inquire the latest purchasable magazines through an interface.

Step 1602, the magazine server inquires the current purchasable magazines and returns a list corresponding to the purchasable items to the application program.

Step 1603, the application program initiates a request to the application store according to the ID list returned by the magazine server, requesting to inquire specific information of IAP products corresponding to the IDs of the IAP products, including names, prices, etc.

Step 1604, the application store inquires specific information of IAP products corresponding to IAP IDs, including names, prices, etc. and sends the result to the application program.

Step 1605, the application program shows the information of the purchasable IAP products to the user according to the result returned by the application store for the user to purchase.

Step 1606, the user selects one or more products and requests to purchase same.

Step 1607, the application program sends the purchase request of the user to the application store, wherein the key information of the purchase request is the corresponding ID of the IAP to be purchased, and the purchasing price.

Step 1608, the application store processes the purchase request, performs fee deduction on the user, returns the result that the application program succeeds or fails to perform fee deduction, if the fee deduction is performed successfully, then a fee-deducted voucher needs to be carried in the returned parameters, and the fee-deducted voucher can be an encrypted character string.

Step 1609a, the application program judges the result of the fee deduction, if it fails, then the flow ends.

Step 1609b, the application program judges the result of the fee deduction, if it succeeds, then the result that the fee deduction is performed successfully is sent to the application program server.

Step 1610, after receiving the fee-deducted voucher, the application program server decrypts and verifies the encrypted character string in the fee-deducted voucher, if the voucher is valid, then the application program delivers the magazine purchased by the user to the user.

Step 1611, the application program obtains the purchased magazine, the user can read the magazine which is purchased successfully, and the flow ends.

It can be found from the above-mentioned flow that there is no direct interface arranged between the application store and the application program server. Therefore, it is possible that the address of the application program server can be modified, and it is not reasonable to maintain the information of the application program server at the application store side. Therefore, the application program developed by the developer needs to send some information between the application store and the application program server in the flow of the IAP, for example, in Step 1610, after receiving the massage that the application store performs fee deduction successfully, the application program needs to deliver this piece of information to the application program server. There is a key point here, it is that the fee-deducted voucher needs to be encrypted, otherwise, once the application program is tampered, it will results in a series of transitional information of counterfeit payment.

One simpler method for the implementation is that the developer applies for a check code for the application in the application store. The application store provides the method for encrypting and decrypting the purchase voucher and checking rules in the developer manual. After performing fee deduction successfully, the application store uses the check code to encrypt the purchase voucher. When the purchase voucher is delivered to the application program server through the application program, the application program server decrypts the purchase voucher according to the check code and checks the purchase voucher according to the checking rules provided by the application store, and when the purchase voucher is judged to be valid, the content or service purchased by the user is delivered to the user. It should be noted that the above processing manner only provides a preferable solution, various kinds of alterations and changes of the encryption to the purchase voucher, if only having the same principle, are all included in the scope of the protection of the disclosure.

In the above-mentioned embodiment, if the developer hopes to upload the latest issue of the magazine, only one IAP purchasable item, such as 20______ (year), ______ (month), XX magazine, pricing at 4 Yuan, needs to be added to the IAP management module of the application store, and the application store allocates an IAP ID for the IAP purchasable item. The developer serves and maintains the information of the magazine in the application store according to the IAP ID. The user does not need to update the application program completely when downloading the latest issue of the magazine by using the magazine reader. This form of IAP function management reduces the workload of the developer, and meanwhile simplifies the operation of the user.

In conclusion, with the solution provided by the embodiments of the disclosure, when developing an application having an IAP function, a developer does not need to configure a purchase function in an application server, which simplifies the complexity for a developer to develop an application. At the same time, it is easy to realize the management and maintenance to the purchasable items through the architecture, which simplifies the operation of the user.

Obviously, those skilled in the art shall understand that the above-mentioned modules and steps of the disclosure can be realized by using general purpose calculating device, can be integrated in one calculating device or distributed on a network which consists of a plurality of calculating devices. Alternatively, the modules and the steps of the disclosure can be realized by using the executable program code of the calculating device. Consequently, they can be stored in the storing device and executed by the calculating device, or they are made into integrated circuit module respectively, or a plurality of modules or steps thereof are made into one integrated circuit module. In this way, the disclosure is not restricted to any particular hardware and software combination.

The descriptions above are only the preferable embodiment of the disclosure, which are not used to restrict the disclosure, for those skilled in the art, the disclosure may have various changes and variations. Any amendments, equivalent substitutions, improvements, etc. within the principle of the disclosure are all included in the scope of the protection of the disclosure.

1. An application store system, comprising: a developer community functional entity and an online application store functional entity, further comprising:
a configuration module, configured to accept an operation of configuring, for an application, one or more purchasable items corresponding to the application and information corresponding to the one or more purchasable items, wherein the application is uploaded through the developer community functional entity; and
an In-Application Purchase (IAP) processing module, configured to receive a purchase request from the application, and perform fee deduction according to the information corresponding to one or more purchasable items that the purchase request requests to purchase.

2. The system according to claim 1, wherein
the configuration module and the IAP processing module are located in the developer community functional entity; or,
the configuration module is located in the developer community functional entity, the IAP processing module is located in the online application store functional entity, and an interface between the developer community functional entity and the online application store functional entity is configured to synchronize the one or more purchasable items and the information corresponding to the one or more purchasable items to the IAP processing module.

3. The system according to claim 1, wherein the IAP processing module comprises:
a purchase request interface, wherein the purchase request interface is configured to receive the purchase request from the application, and perform fee deduction according to the information corresponding to the one or more purchasable items that the purchase request requests to purchase; or,
a purchase request interface and a purchase request responding interface, wherein the purchase request interface is configured to receive the purchase request from the application, and perform fee deduction according to the information corresponding to the one or more purchasable items that the purchase request requests to purchase; and the purchase request responding interface is configured to return a purchase success message to the application under the condition that the purchase request interface performs the fee deduction successfully.

4. (canceled)

5. The system according to claim 3, wherein the purchase request responding interface is configured to, under the condition that the one or more purchasable items for which the fee deduction is performed successfully are one or more items which have been downloaded in the application, return the purchase success message carrying information of the one or more purchasable items for which the fee deduction is performed successfully; and configured to, under the condition that the one or more purchasable items for which the fee deduction is performed successfully are one or more items which have not been downloaded in the application, return the purchase success message carrying an encrypted fee-deducted voucher.

6. The system according to claim 5, wherein under the condition that the one or more purchasable items for which the fee deduction is performed successfully are one or more items to be downloaded in the application, the encrypted fee-deducted voucher carried in the purchase success message returned by the purchase request responding interface is obtained in the following way:
using a check code corresponding to the application and applying an encryption algorithm to encrypt the fee-deducted voucher, wherein the check code, the encryption algorithm and a validation rule corresponding to the application are configured in an application server provided for the application to download the one or more purchasable items for which the fee deduction is performed successfully.

7. The system according to claim 1, wherein the IAP processing module comprises:
an IAP query interface, configured to receive a query request from the application and inquire one or more purchasable items according to the query request; and
an IAP query responding interface, configured to return inquired information of the one or more purchasable items to the application.

8. The system according to claim 1, wherein the configuration module and the IAP processing module are located in an IAP management module of the application store system.

9. The system according to claim 8, wherein the IAP management module is arranged in the developer community functional entity.

10. A developer community functional entity, comprising:
a configuration module, configured to accept an operation of configuring, for an application, one or more purchasable items corresponding to the application and information corresponding to the one or more purchasable items, wherein the application is uploaded through the developer community functional entity.

11. An online application store functional entity, comprising:
an IAP processing module, configured to receive a purchase request from an application, and perform fee deduction according to information corresponding to one or more purchasable items that the purchase request requests to purchase, wherein one or more purchasable items and the information corresponding to the one or more purchasable items are synchronized to the IAP processing module by an interface between the developer community functional entity and the online application store functional entity.

12. The online application store functional entity according to claim 11, wherein the IAP processing module comprises:
a purchase request interface, configured to receive the purchase request from the application, and perform fee deduction according to the information corresponding to the one or more purchasable items that the purchase request requests to purchase.

13. The online application store functional entity according to claim 12, wherein the IAP processing module further comprises:
a purchase request responding interface, configured to return a purchase success message to the application under the condition that the purchase request interface performs the fee deduction successfully.

14. The online application store functional entity according to claim 11, wherein the IAP processing module further comprises:
an IAP query interface, configured to receive a query request from the application and inquire one or more purchasable items according to the inquired request; and
an IAP query responding interface, configured to return the inquired information of the one or more purchasable items to the application.

15. A method for realizing an In-Application Purchase (IAP) function, comprising:
in response to a user operation of selecting one or more purchasable items to be purchased, an application initiating a purchase request to the application store system;
the application store system receiving the purchase request from the application, and performing fee deduction according to information corresponding to the one or more purchasable items that the purchase request requests to purchase.

16. The method according to claim 15, wherein after the application store system receives the purchase request from the application, and performs the fee deduction according to the information corresponding to the one or more purchasable items that the purchase request requests to purchase, the method further comprises:
the application receiving a purchase success message returned by the application store system under the condition of performing the fee deduction successfully;
under the condition that the one or more purchasable items for which the fee deduction is performed successfully are one or more items which has been downloaded in the application, the application authorizing to use the one or more purchasable items for which the fee deduction is performed successfully according to information of the one or more purchasable items for which the fee deduction is performed successfully which is carried in the purchase success message; and under the condition that the one or more purchasable items for which the fee deduction is performed successfully are one or more items which has not been downloaded in the application, the application sending an encrypted fee-deducted voucher carried in the purchase success message to an application server provided for the application to download the one or more purchasable items for which the fee deduction is performed successfully.

17. The method according to claim 16, wherein after the application sends the encrypted fee-deducted voucher carried in the purchase success message to the application server provided for the application to download the one or more purchasable items for which the fee deduction is performed successfully, the method further comprises:
the application server decrypting and verifying the encrypted fee-deducted voucher, and transferring service content of the one or more purchasable items for which the fee deduction is performed successfully to the application under the condition that the fee-deducted voucher is valid.

18. The method according to claim 15, wherein before the application initiates the purchase request to a purchase request processing module, the method further comprises:
the application initiating a query request to the application store system;
the application store system inquiring one or more purchasable items according to the query request, and returning the inquired information of the one or more purchasable items to the application; and
the application displaying the received information of the purchasable item.

19. The system according to claim 3, wherein the configuration module and the IAP processing module are located in an IAP management module of the application store system.

20. The system according to claim 5, wherein the configuration module and the IAP processing module are located in an IAP management module of the application store system.

21. The system according to claim 6, wherein the configuration module and the IAP processing module are located in an IAP management module of the application store system.

22. The system according to claim 7, wherein the configuration module and the IAP processing module are located in an IAP management module of the application store system.
